(19) United States
(12) Patent Application Publication
(10) Pub. No.: US 2020/0403893 A1
(43) Pub. Date: Dec. 24, 2020

(54) METHOD TO DETERMINE A PROPAGATION DELAY OF A MULTIMEDIA STREAM OF A VIDEO CONFERENCE COMMUNICATION SYSTEM

(71) Applicant: TOPICA HOLDING PTE. LTD, SINAGPORE (SG)

(72) Inventors: Tran Minh SON, Sceaux (FR); Luu Quoc TUAN, Ha Noi (VN); Bui Thank KHIET, Ha Noi (VN)

(73) Assignee: TOPICA HOLDING PTE. LTD, SINAGPORE (SG)

(21) Appl. No.: 16/450,451

(22) Filed: Jun. 24, 2019

(51) Int. Cl. H04L 12/26; H04N 21/2389; H04L 29/06; H04N 21/242

(52) U.S. Cl. CPC H04L 43/0852; H04N 21/242; H04L 65/605; H04N 21/23892

(57) ABSTRACT

A video conference method and system to determine a propagation delay of a multimedia stream of a video conference communication system, the multimedia stream having a first format, the method including: obtaining an emission time, converting the emission time into a multimedia component, inserting the multimedia component into the multimedia stream at the emission side while keeping the same first format, detecting the inserted multimedia component at the reception side, retrieving from the multimedia component the emission time, obtaining a current reception time, and calculating the propagation delay by the time difference between the emission time and the current reception time.

### INTRODUCTION

Video conferencing is largely used not only in the professional environment, but also for one-to-one communication between two individuals or to follow an interactive on-line session distributed by a server.

In a video conferencing system, a participant generates at least an audio and video stream. At the same time, that participant receives at least one return channel from the counterpart(s). A video conferencing system can further comprise a metadata channel to send information or instruction to the recipient. The return channel can comprise various elements such as the audio of the recipient, the video of the recipient, commands entered by the recipient, or a combination of the previously mentioned elements.

### SUMMARY

The aim of the present disclosure is to determine a propagation delay of at least one multimedia stream. The propagation delay is defined as the time between the emission of the multimedia stream from the emitter to the arrival of said multimedia stream at the receiver's location. As previously mentioned, the video conferencing system generates at least two multimedia streams, one of the video and one for the audio.

In the frame of the present disclosure, it is proposed a method to determine a propagation delay of a multimedia stream of a video conference communication system, said method comprising:
obtaining an emission time,
converting the emission time into a multimedia component,
inserting the multimedia component into the multimedia stream at the emission side while keeping the same format of the multimedia stream,
detecting the inserted multimedia component at the reception side,
retrieving from the multimedia component the emission time,
obtaining a current reception time,
calculating the propagation delay by the time difference between the emission time and the current reception time.

### SHORT DESCRIPTION OF THE FIGURES

The present description will be better understood with the help of the attached figures, given in as non limiting examples, in which:

FIG. 1 illustrates a conventional video conferencing system,

FIG. 2 illustrates an example a method and system to determine the propagation delay such video conference, where media data are transmitted in an opaque manner (end-to-end solution provided by a third-party)

FIG. 3 illustrates an example in which some delays intrinsic to the detection method are taken into account in the video stream,

FIG. 4 illustrates an example in which some delays intrinsic to the detection method are taken into account in a audio stream,

FIG. 5 illustrates an example in which the video stream comprises a graphical element comprising time information,

FIG. 6 illustrates an example of a combination of the detection on the video and the audio stream.

FIG. 7 illustrates an example to measure the video propagation in a video conference

FIG. 8 illustrates an example to embed and retrieve timestamp in ClickButton event

FIG. 9 illustrates an example to embed and retrieve timestamp in Drag and Drop event

FIG. 10 illustrates an example to embed and retrieve timestamp in Drawing event

### DETAILED DESCRIPTION

In order to detect the propagation time of a multimedia stream, a specific component is inserted at the emission side representing the emission time and the same component is detected at the reception side.

This specific component is called “multimedia component” since it will be integrated in one multimedia stream. A multimedia component is compatible with the multimedia stream, so that the insertion of the multimedia component does not alter the format of the multimedia stream.

In addition, the multimedia component comprises time information related to the emission of said multimedia component, in the sense that the reception of the multimedia component by a receiver allows the latter to determine the emission time.

To keep the multimedia format unchanged, the insertion of the multimedia component is performed in different way in accordance with the nature of the multimedia stream: video, audio and synchronized metadata.

### Video stream

According to a first example, the multimedia component is inserted into the video stream. The format of the video stream is not altered and the insertion can be made by overlaying the multimedia component into the existing images of the video stream or can replace one section of the images of the video stream.

The multimedia component exhibits time information. This can be achieved through different modes:

### Text mode

According to a first embodiment, the current time, as determined by the emitter, is converted into text to form the multimedia component. This text is then overlaid or replaced in one section of at least a portion of the images of the video stream.

Current time can be understood as hours, minutes, seconds and tenth/thousandth of seconds. However, for determining the propagation delay—in the range of seconds or second's fragments, the hours and minutes can be discarded.

### Image Mode

The current emission time, as defined above, can be converted into an image such as a barcode or a QR code, forming the multimedia component. The current emission time is converted into an image that can be recovered at the reception side, this image carrying information to retrieve the emission time. Any watermarking/fingerprinting techniques (they can be either visible or invisible) which are well known by skilled person of the art can be deployed here as alternative embedding method.

The multimedia component (which could be a watermarking or fingerprinting object) can be inserted to one or several images of a portion of the video stream. According to a preferred embodiment, the location into the original image is known from the reception side. It is for example at the left corner of the original image, allowing the receiver to focus the detection of the multimedia component only into this section of the image.

### Auto-Syncho Mode

In this mode, the multimedia component is a single element of a given form. It could be a square, a circle or any form that will be detected at the reception side. The particularity of the single element is that no time information can be extracted from this form. The video conferencing server waits until the current time, as far as the seconds are concerned (and the tenth of seconds) are zero and the single element is inserted into a portion of the multimedia stream. As a consequence, the single element can be inserted every minute at the change of the minute. The presence of the single element exhibits a time information equal to 00.00 in seconds. We have used the example in which the reference time is 00.00 but any time can be used (for example 10′00″) as long as the selected time is known at the reception side.

### Audio Stream

The multimedia component can be inserted into the audio track of the video conferencing system. According to a first embodiment, the current time is converted into an audio component in a known method called Text to Speech. The audio component is then added with the current audio track.

According to a second embodiment the current time is converted into DTMF (Dual Tone Multi Frequency) and added into at least a portion of the current audio track.

According to another embodiment, the modulation of the audio component is at the limit of the audible range, for example for frequency above 16 kHz. The insertion of the emission time will not be audible by the receiver.

Any other audio watermarking/fingerprinting techniques (they can be either audible or inaudible) which are well known by skilled person of the art can be deployed as alternative embedding method.

### Auto-Synchro Mode

In the same manner as the auto-synchro mode described above, a single audio element is inserted at the reference time. It can be a spike at a higher frequency such as 16 kHz for easy detection by the receiver. To avoid any false detection, the server can insert two spikes with a known interval in between.

### Synchronized Metadata Stream

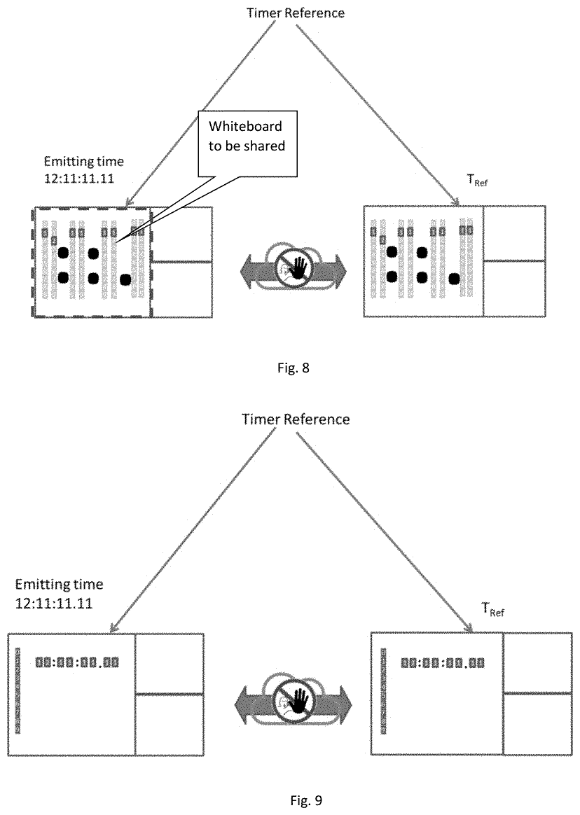

In some video conference (or in some Remote Accessing Application like TeamViewer), several events are transmitted to recipients such as Button Click, Drawing Shape, Drag and Drop objects, Typing Text. . . . Such video conference application often has a surface—white board to be shared (see FIG. 8). The content displayed on the whiteboard can be predefined (consisting of interactive objects) or just blank At the emitter, whenever some events happen within the whiteboard area, they will be replicated at the recipients in time order (that is why they are referred to as synchronized metadata) with a probably observable delay.

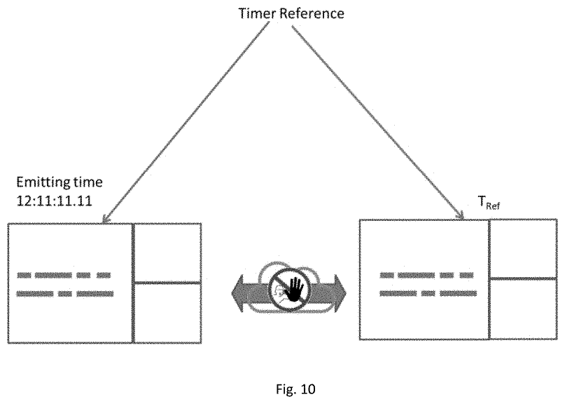

In another embodiment, the multimedia component is inserted into the synchronized metadata. In order to create a metadata consisting meaningful timestamp data, Robotic Process Automation (RPA) is used. A skilled person in the art know how to use such RPA tools like UIPath, AutomationAnywhere, . . . to produce the events like ButtonClick, Drawing Shape, Drag and Drop objects—the multimedia component to be embedded—precisely on the whiteboard area without human interaction. FIG. 8, FIG. 9 and FIG. 10 are various ways to embed timestamps into different event type.

### ButtonClick Mode

On the whiteboard area, a predefined content=consisting of buttons having face-name from 0 to 9=is display to all video conference participants as in FIG. 8. The buttons are vertically rendered into a column. There are 8 columns, grouped into 4 sets of 2 columns, which correspond to 2 digits of the timestamps' elements: hour, minute, second and millisecond. At the emitting time, the RPA tool is programmed to get the time from the Timer Reference Unit. The tool then automatically clicks onto the proper buttons to embed/show the timestamp T (it is 12 h 11 m 11 s and 11 millisec in FIG. 8). After a Δt_{Delay} these buttons will be clicked (hence changed their color to dark blue) as at the emitter.

### Drag and Drop Mode

Similar to the Button Click mode, the whiteboard area will be filled with a predefined content as shown in FIG. 9. There are 10 draggable objects, named from 0-9. The dropped zones are 8 positions corresponding to 2 digits of 4 timestamps' elements: hour, minute, second and millisecond. The RPA tool is used to drag the correct digits to the right places in order to display the emitting time. After a Δt_{Delay} the same drag and drop actions will be performed at other recipients.

### Drawing Shape Mode

In this mode, the RPA tool is programmed to draw—to click the left button of the mouse and hold pressed then release the button—the Morse symbols as in FIG. 10. The shorter and the longer drew lines are assigned to the “dot” and the “trait” Morse symbols respectively. In this mode, the timestamps will be drawn as a Morse codes on the whiteboard area. After a Δt_{Delay} the same Morse code will be visible at other recipients.

As an embodiment, several multimedia components are inserted into several media streams in parallel. The timestamp embedded in each multimedia component can be varied for each media type for different compensation method applied to each media type, i.e. a first multimedia component can be inserted into the video stream and a second multimedia component can be inserted into the audio stream and a third multimedia component is inserted into the synchronized metadata.

After inserting media components into the associated media streams as described above, the video conferencing system can send the streams to one or more recipients.

In the frame of the present disclosure, we will consider two embodiments as far as the reception side (performed at each recipient) in concerned. The first one is the embodiment in which the receiver of the streams encompasses the rendering elements (screen and audio speaker) and the analysis and determination elements of the propagation side. The second one is another embodiment in which the receiver consists of two devices: a first device to receive and render the audio and video streams and a second independent device to analyze the streams and determine the propagation delay. The second device comprises acquisition means to acquire either the image rendered by the reception device with as a camera, or a microphone to acquire the sound produced by the reception device, or both.

For the subsequent description, we will refer to the reception device and the detection device, these two devices being two distinct devices or one single device comprising the elements of both devices.

Similar to the inserting process, handling process at the reception and the detection device strongly depend on the multimedia stream's type.

### Video Stream

The video stream comprises the multimedia component as explained before. The role of the detection device is to retrieve the multimedia component from the images of the video stream. Preferably, the location of the multimedia component is known by the detection device and the detection device can only analyze a section of the full images.

In the case of a text overlaid in a section of the image, or a text replacing one section of the full image, the detection device executes a OCR (Optical Character Recognition) to convert the image of the emission time into a suitable electronic format (computer readable format).

In the case that the multimedia component is an image comprising a QR code or a barcode, the detection device detects the presence of this element and converts the information carried by this code into a suitable electronic format.

In the case that the multimedia component is a single element such as a circle of a square, the detection of such element defines the emission time as 0.00 (or the predefined reference time if another reference was chosen).

The retrieved time the above is called the emission time. At the same time, the detection device determines the current time at the detection device. This can be obtained from an internal clock generator or by fetching the current time from a remote reference source of the detection device.

The detection device is now in a position to determine the propagation delay by subtracting the emission time from the current time.

### Audio Stream

In the case that the multimedia component is inserted into the audio track of the video conferencing system thanks to the Text to Speech operation for example, the detection device uses the Speech to Text to retrieve back the emission time from the audio stream. In order to correctly detect the emission time (the origin audio stream may also have some other time information), in an embodiment of the application, the embedding operation with Text to Speech adds a unique vocal pattern as a prefix to the emission time. As a result, the detection device can be activated in only with the occurrence of the vocal pattern in order to be ready to fetch the emission time from the audio stream.

In case of the DTMF or audio watermarking, the complement filter will be used to retrieve the emission time.

In the case of frequency above 16 kHz, the bypass filter of the embedded frequency will be applied to the audio stream to extract the emission time.

### Synchronized Metadata Stream

In case of the Click button mode, the detection device will wait until 8 digits of the time elements are activated/clicked at the recipient. With the aid of OCR, the emission time can be retrieved. The time at the moment the very first digit is activated can be considered as the arrival time/current time. The difference between the current time and the emission time is the delay propagation.

In fact the emission time is the moment that the first button/digit is activated at the emitter. If Δt_{Gen} is the passed time between the fact that the first digit and the last digit are activated, the correct emission time must be the sum of the retrieved emission time and Δt_{Gen}. Therefore to increase the precision, each time an emission time is embedded with a Click button mode, its Δt_{Gen} also registered and sent to the analyzer device.

In case of the Drag and Drop mode, the OCR is similarly applied to retrieve the emission time. Here Δt_{Gen} is the passed time between the fact that the first and the last digit are completely dropped into their places.

In case of the Drawing mode, the visual Morse decoder is applied to extract the emission time. Here Δt_{GEN} is the duration between the fact that the first and the last Morse symbol are drawn.

In case where several multimedia components are inserted into several streams, the propagation delay for each stream can be derived as explained above. Then the relative delay between the streams—the desynchronization/jitter effect between audio/video/synchronized metadata can be then computed by taking the subtraction of the resulting propagation delay for each media type

Combination of modes in one embodiment, the detection device comprises communication means with the emitter such as the video conferencing system. The propagation time is then reported to the system along with identification of the recipient. If the propagation time exceeds certain threshold, any well-known alarm systems like SMS, Messaging, Audio Alarming System, . . . can be activated to trigger any pre-defined emergency procedure.

The figures are now discussed in detail to illustrate the above embodiments.

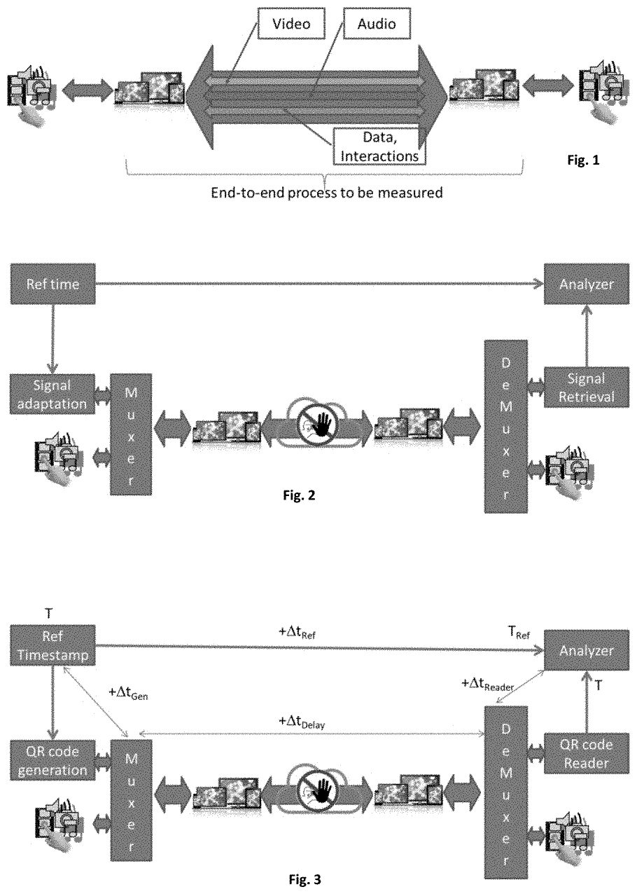

The FIG. 1 illustrates the end-to-end process in a video conferencing system. It is to be noted that this data path can be one way, i.e. one side is defined as the emitter sending audio video, and metadata to a receiver, or two-ways, i.e. the receiver transmits also audio video and metadata to the emitter.

The main purpose of the present disclosure is to determine the propagation time of audio or video or synchronized metadata stream from one emitter to a receiver.

The FIG. 2 illustrates the main process of the present disclosure. The left side is defined as the emitter and the right side is the receiver. A reference time (i.e. the emission time) is acquired by the emitter (Ref Time) and converted into a multimedia component. This is achieved through a Signal Adaptation module. The multimedia component is then multiplexed with the conventional audio or video or synchronized metadata (or all of these types) stream of the video conferencing is order to be part of the data streams sent to the receiver.

On the receiver side, the Demuxer extracts one of the streams (audio or video or or synchronized metadata or all of these types) and pass it to a Signal Retrieval. This module is in charge of detecting the presence of the multimedia component. Once the multimedia component is detected, the emission time is retrieved from the multimedia component and compared with a freshly acquired reference time. This reference time is called the reception time, i.e. the time at which the multimedia component was detected by the receiver.

The receiver can then calculate the propagation time.

FIG. 7 illustrate a simplified embodiment of the invention to measure the delay propagation via video transmission. The bottom left and the bottom right images are 2 graphic user interfaces (GUI) of a video conference whose video delay is measured. In each GUI, two video streams can be viewed simultaneously: the local webcam and the remote webcam (2 sub-windows in the middle of the GUI FIG. 7). Two users of the video conference all aim the webcams to the same Timer Reference. Due to the delay propagation, there will be two different timestamps displayed on the GUI: the Tref is the direct time coming from the Timer Reference via the local webcam and the T is the indirect time also coming from the Timer Reference (in the past) via the remote webcam then passing through the video conference transporting system. In this simplified embody the difference between Tref and T gives the delay propagation.

In the FIG. 3, several delays in the determination of the propagation time can be taken into account in order to increase the accuracy. The propagation time of either the video or the audio stream varies from 100 ms to several seconds. The precision can be improved by taking into account the processing time of the components leading to the determination of the propagation delay Δt_{Delay}.

The FIG. 3 takes the specific example of the multimedia component being a QR code but the same delays and precision improvements can be used to all types of way to generate the multimedia component.

In the example of the FIG. 3, we will take into account the time necessary to generate the QR code embedding the emission time (named Ref Timestamp in the FIG. 3). This duration is named Δt_{Gen} and represents the time to generate a QR code and inserting it into the video stream toward the receiver. According to one embodiment, the reference time fetched by the emitter is corrected by adding the time Δt_{Gen} so that the QR code comprises the Emission time=Ref time+Δt_{Gen}. The time Δt_{Gen} is predetermined/pre-calibrated for a given video conferencing system.

On the receiver side, the detection and the extraction of the QR Code (or any type of multimedia component) also takes time. This extraction time, called Δt_{Reader} can be dependent of the processing capabilities of the receiver. This extraction time is predefined/pre-calibrated per type of receiver.

Once the emission time is extracted from the multimedia component, the Analyser subtracts from the fetched reference time (or current time), the extraction time to have a more accurate time of arrival of the multimedia component.

The Analyser can take into account the fetching time of the current time. To ensure a better calculation of the propagation time, the Analyser fetches the current time at the same location as the emitter. The time to fetch the current time can be determined by appropriate tools such as the known command “ping” that returns the time to access a given Internet address.

The fetch time Δt_{Ref} is then added to the current time fetched by the Analyser and is then taken into account for the calculation of the propagation time.

According to one embodiment, all the noisy duration Δt_{Ref}, Δt_{Gen}, and Δt_{Reader} can be pre-calibrated and be conveyed/saved at the Analyser. One can then derive the Δt_{Delay} as the following:

Δt_{Delay}=T_{Ref}−T−Δt_{Gen}−Δt_{Reader}−Δt_{Ref}

The FIG. 4 illustrates the case of the insertion of the multimedia component into the audio stream. The emission time fetched from the Ref Time source is converted into speech. The audio component is thereafter mixed with the conventional audio stream of the video conferencing system and sent to the receiver.

In order to improve the accuracy of the measurement, the time to convert and modulate the emission time into speech (Δt_{Text2Speech}) is taken into account and added into the time fetched from the reference source before it is converted into speech.

In the same manner, the time to convert the speech in the receiver side into text (Δt_{Speech2Text}) is taken into account in the calculation of the propagation time At Δt_{Delay}. This time is subtracted from the time T_{Ref} fetched by the Analyser to take into account the conversion.

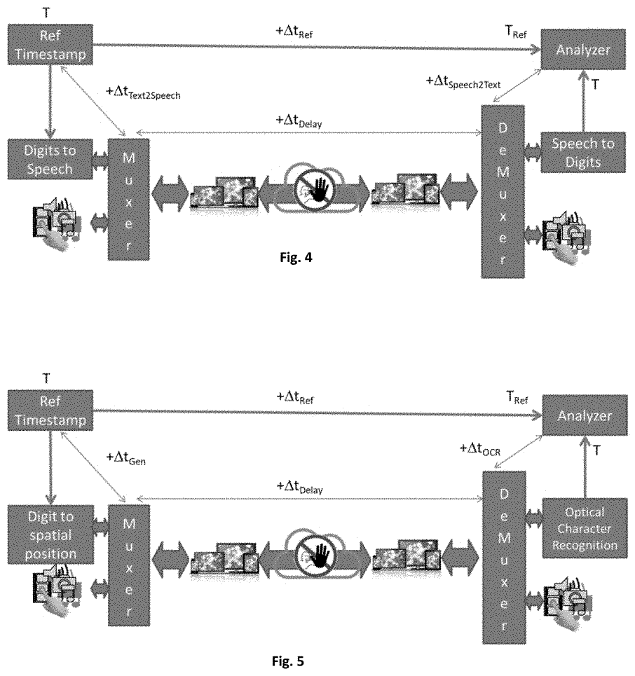

The FIG. 5 illustrates the same mechanism with the insertion into the video stream of text in a form of a graphic representing the emission time. The current time as determined by the emitter is converted into graphic and multiplexed with the video stream. This insertion can be a replacement of a section of the original image or an overlay onto the original image. This operation to convert a reference time into a graphic (time Δt_{Gen}) is added to the reference time T in order to have a more accurate emission time.

At the receiver side, the video stream is analysed and an Optical Character Recognition module converts the emission time into text. This text, representing the emission time is passed to the Analyser and with the current time T_{Ref}, the propagation time Δt_{Delay} is calculated.

The time to convert a graphic into text with an OCR (Δt_{OCR}) as described above is taken into account in the calculation of the propagation time.

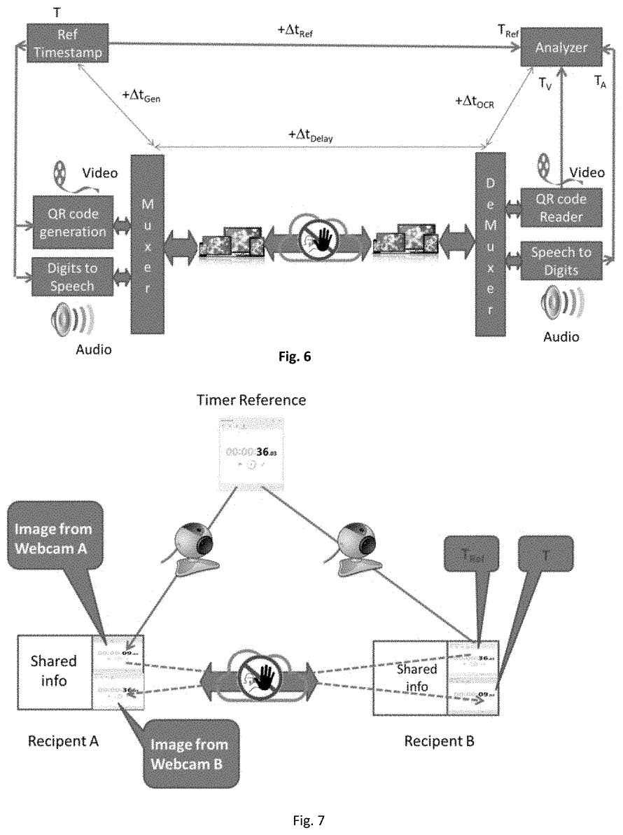

The FIG. 6 illustrates a combination of an audio and a video component representing the emission time inserted into the audio and video stream respectively. In this figure, we have used the example with the QR code. The audio component is the result of a text to speech conversion.

On the receiver side, the Analyzer will determine two emission times, the audio emission reception time for the audio component and the video emission time for the video component (here the QR code).

With the reference time TRef, the audio propagation delay is calculated with the audio emission time and the reference time, the video propagation delay being calculated from the video emission time and the reference time.

The knowledge of the difference between the audio and video stream propagation delay can be used in various way.

It can be used to inform the emitter of this difference and the emitter can buffer the stream with the shortest propagation time to resynchronize both streams.

It can be used by the receiver to resynchronize the stream by applying a buffer to the one having the shortest propagation time.

It can be used for statistic reasons, in order to assess a quality of service.

The insertion and retrieval of the multimedia component is carried out by one a several processors executing a program stored in a memory. The processor or processors execute the method as highlighted above and determine the propagation delay. On the emission side, the video conferencing system comprises audio and video processing means to prepare a suitable multimedia experience for the receiver. The video conferencing system can be connected to a camera to record a presentation of a teacher. A microphone is used to record the voice produced by the teacher. The video conferencing system processes these sources and can add synchronized metadata to produce a stream comprising these three elements. The video conferencing system has access to a realtime source to obtain a precise time reference. This time is used to define the emission time. The audio or video processing means can then insert the multimedia component, comprising the emission time, into the audio and/or video stream. The video conferencing system comprises processing means to modify the synchronized metadata to insert the emission time into the synchronized metadata.

The reception device comprises an input to receive the video conferencing stream. This input is generally connected to Internet in order to establish a connection with the video conferencing system. The reception device comprises means to process the stream and recover the audio, video and metadata streams. The reception device comprises rendering components such as a screen or a loudspeaker. The analyser module, which could be part of the reception device or part of another device such as a smartphone, comprises a processor to execute the method of the present disclosure. The audio stream is analysed to recover the audio multimedia component and determine the emission time.

The video stream is analysed to recover the video multimedia component and determine the emission time. Likewise, the metadata stream is analysed to recover the metadata multimedia component and determine the emission time. The analyser module comprises means to seek a reference time and determine the reception time extracted from the multimedia component and therefore determine the propagation delay.

Although embodiments of the present disclosure have been described with reference to specific example embodiments, it will be evident that various modifications and changes may be made to these embodiments without departing from the broader scope of these embodiments. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived there from, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method to determine a propagation delay of a multimedia stream of a video conference communication system, said multimedia stream having a first format, said method comprising:
obtaining an emission time;
converting the emission time into a multimedia component;
inserting the multimedia component into the multimedia stream at the emission side while keeping a same first format;
detecting the inserted multimedia component at the reception side;
retrieving from the multimedia component the emission time;
obtaining a current reception time; and
calculating the propagation delay by determining the time difference between the emission time and the current reception time.

2. The method of claim 1, wherein the said multimedia stream comprises an audio and video stream, said multimedia component being embedded into the said video stream;
said detecting step comprising analyzing the video stream in order to detect the presence of the multimedia component in at least one of the images;
said retrieving step comprising analyzing all or part of the multimedia component to retrieve the emission time.

3. The method of claim 2 further comprising:
updating the multimedia component with an updated emission time, said updated emission time being in advance compared with the emission time previously inserted into the multimedia stream;
inserting the updated multimedia component into the multimedia stream; and
at the reception side, calculating a second propagation time based on the updated multimedia component.

4. The method of claim 3, wherein the multimedia component is inserted into the video stream as a text exhibiting the emission time, said text being updated to follow the emission time.

5. The method of claim 1, further comprising:
determining a first processing delay between the time of obtaining the emission time and the time of inserting the multimedia component; and
removing from the calculated propagation delay the first processing delay.

6. The method of claim 1, further comprising:
determining a second processing delay corresponding to the time to detect and retrieve the emission time from the multimedia stream; and
removing from the calculated propagation delay the second processing delay.

7. The method of claim 1, further comprising:
determining a third processing delay corresponding to the time to obtain the current reception time; and
removing from the calculated propagation delay the third processing delay.

8. The method of claim 2, wherein the multimedia component is a visible or invisible watermark embedded into all or some video frame in the video stream, the watermark comprising the emission time.

9. The method of claim 1, wherein the multimedia component is a QR code inserted into the video stream, the QR code comprising the emission time.

10. The method of claim 1, wherein the multimedia component is an audio pattern embedded into the audio stream, the audio pattern comprising the emission time.

11. The method of claim 1, wherein the multimedia component is an imperceptible audio watermark embedded into the audio stream, the audio watermark comprising the emission time.

12. The method of claim 1, wherein the multimedia stream is a synchronized metadata stream carrying information for the video conference, said multimedia component is a special metadata unit of said synchronized metadata stream, said special metadata unit being mapped identically to the emission time; and
said obtaining step comprising inverse mapping the special metadata unit back to the emission time.

13. The method of claim 1, wherein said synchronized metadata stream carries the spatial position of mouse clicks on a whiteboard shared during the video conference, said special metadata unit being a series of spatial positions corresponding to Morse coded symbols representing the emission time; and
said obtaining operation being the Morse decoding process to read the emission time.

14. The method of claim 1, wherein when the propagation delay exceeds a predefined threshold, triggering an alarm via any online or offline information transmitting system.

15. The method of claim 14, wherein said online information transmitting system is the FACEBOOK™ messenger system.

16. The method of claim 14, wherein said offline information transmitting system is an e-mail system.

17. A receiving device configured to receive a video conferencing stream comprising at least an audio and a video stream, said audio or video stream comprising a multimedia component exhibiting the time of the emission in at least a portion of said stream, said receiving device comprising an analyzer to extract the multimedia component from the portion of the stream and to recover the emission time, the receiving device further comprising a reference time seeker to fetch the current time and calculator to determine a propagation time of the stream by subtracting the current time from the emission time.

18. The receiving device of claim 17, wherein the multimedia component is part of the audio stream, said analyzer being configured to extract the audio component from the audio stream to recover the emission time from the audio component.

19. The receiving device of claim 17, wherein the multimedia component is part of the video stream, said analyzer being configured to extract the video component and convert the video component into the emission time.

20. The receiving device of claim 19, wherein the video component is a QR code or a barcode, said QR code or barcode embedding the emission time, said analyzer being configured to convert the QR code or barcode into plain data representing the emission time.
